(19) United States
(12) Patent Application Publication
(10) Pub. No.: US 2024/0175298 A1
(43) Pub. Date: May 30, 2024

(54) A CHILD SAFETY LOCK FOR CABINETS AND DRAWERS

(71) Applicant: DIOMOD ARGE INOVASYON MÜHENDISLIK SANAYI TICARET LIMITED SIRKETI, ISTANBUL (TR)

(72) Inventors: Erdogan CEBIR, ISTANBUL (TR); Saffet GÜLESÇI, ISTANBUL (TR); Mehmet Selim ESMER, ISTANBUL (TR)

(21) Appl. No.: 18/548,860

(22) PCT Filed: Dec. 13, 2021
(86) PCT No.: PCT/TR21/51397

§ 371 Date: Sep. 1, 2023

(30) Foreign Application Priority Data
Mar. 4, 2021 (TR) 2021/004258

(51) Int. Cl. E05B 65/00; E05B 65/462; E05C 3/00; E05C 3/14; E05C 7/00

(52) U.S. Cl. CPC E05B 65/0014; E05B 65/462; E05C 3/004; E05C 3/145; E05C 7/00

(57) ABSTRACT

A child safety lock mechanism for cabinets and drawers includes at least one right wall, at least one left wall, at least one lower tab lever, an upper button spring; a lower button spring; an upper button spring cover; a lower button spring cover; an upper leg; a lower leg; a double-sided tape for a right wall; a double-sided tape for an upper leg; and a double-sided tape for a lower leg. The child safety lock for cabinets and drawers includes a mechanism which is externally integrated to the cabinets and drawers for preventing material and non-material damages, particularly children's health, by preventing a children from reaching all kinds of articles in the form of a cabinet and drawer in the houses and offices, wherein the mechanism allows the cabinets and drawers to be opened only by the adults.

### TECHNICAL FIELD

The invention relates to a Child Safety Lock for Cabinets and Drawers is related to a mechanism which is externally integrated to the cabinets and drawers for preventing the material and non-material damages, particularly children's health, by preventing the children from reaching all kinds of articles in the form of a cabinet and drawer in the houses and offices, wherein the mechanism allows the cabinets and drawers to be opened only by the adults.

### STATE OF THE ART

A mechanism is disclosed, which is integrated between a drawer or a cabinet and a supported framework therefor in order to provide child safety by preventing the drawers and cabinets from opening by children and to avoid material and non-material damages, wherein the main body of the mechanism comprises a right wall, a left wall, an upper tab lever, a lower tab lever, an upper button spring, a lower button spring, an upper button spring cover, and a lower button spring cover, wherein for a drawer, the body of the mechanism is disposed on the side walls of the framework so as to be located between the rails of two drawers, and for a cabinet, it is disposed at the center of the roof or base of the framework, wherein for the drawers, the locking and unlocking processes are performed by the upper leg and lower leg inserted into the lower or upper portions of the drawer fronts so as to correspond to the channels in which the upper tab lever or lower tab lever in the main bodies of the mechanism is located, wherein for the cabinets, the locking and unlocking processes are performed by the upper leg and lower leg disposed in the cabinets so as to correspond to the channels in which the upper tab lever or lower tab lever in the main body of the mechanism is located, wherein the mechanism locks the drawers and cabinet doors and does not allow them to be unlocked as in normal use, wherein if a drawer or cabinet door is tried to be unlocked, the drawer or cabinet door corresponding to the drawer or cabinet door which is desired to be unlocked is pressed, the upper leg or lower leg on that side triggers the upper tab lever or lower tab lever on the main body of the mechanism, so the drawer or cabinet door desired to be unlocked may be released.

Different implementations exist in the state of the art and are as follows: There exist drawer and cabinet locks which are currently used and designed for the drawers and cabinets to prevent access of the children. The locks which are produced using similar or different methods are only used in drawers, only in cabinets, or both in drawers and cabinets.

Model 1 Gondola-Type Child Safety Lock: This is a child safety lock developed for the cabinet doors. This type of lock integrated externally on the front surfaces of the cabinet doors is not suitable for use in the drawers. It creates an aesthetically unfavorable view as it is mounted on the outer surface of the door. The system which locks the doors together via a lever upon application to the outer surface of the doors at the junction point of two doors causes deformation on the door surfaces as the doors are forced to be unlocked. When the child safety lock is not in use, the deformation formed on the surfaces of the lock removed poses an aesthetically problem. In addition, the children who see the way of unlocking process of the lock performed by their parents learn how to unlock the lock as the locking mechanism is exposed, so the lock becomes meaningless.

Model 2 Child Safety Lock for Cabinets and Drawers with a Strap: This is a child safety lock with a strap which may be used in cabinets and drawers. The child safety locks with a strap have a simple system in which two parts for fixing the strap are attached on an outer surface between the drawer and a fixed surface and prevent the drawer from opening. The locking process is carried out using a strap which is fixed on one leg and a hook, a compressing assembly, or a clip, on the other leg. For the cabinets, the locking process is carried out as for the drawers such that the strap is fixed between two legs fixed on both cabinet doors as mentioned above. They create a visually unfavorable view, the locking and unlocking processes are not user-friendly, they lead to waste of time as they are not practical, they may be unlocked by the children who are at the age of walking and are attracted by them, and the straps in the frequently used cabinets and drawers are deformed and become dysfunctional. Upon elimination of lock use, permanent deformations may be seen on the surfaces from which the locks are removed, and this causes aesthetically adverse outcomes.

Among the other models are U-lock, L-lock with corner clips and Magnetic Inside lock. Beside the magnetic locks, all locks are applied to the outer surfaces of the cabinets and/or drawers, and the above-mentioned disadvantages and problems are encountered. The problems and disadvantages of the magnetic locks are as follows: inappropriate location inside the drawers and cabinets although it is integrated in the interior, taking up space and storing a magnetic apparatus for triggering a magnetic mechanism to open the locked cabinets and drawers and not being ready during use, waste of time, etc.

A Chinese patent with a priority number CN201920472452U included in the state of the art discloses a child lock for drawers, wherein a pressure hook assembly is arranged on the inner side wall of a front side plate of a drawer and is controlled to be twisted by a twisting part, or to be separated under pressure; a limiting assembly is arranged on the pressure hook assembly and is used to limit the separation of the pressure hook assembly and the twisting part. The pressure assembly and the twisting part may be separated, and this does not affect the normal use of the drawer. A child lock for drawers means a drawer which comprises a twisting part located on the inner side wall of a top plate.

### DESCRIPTION OF THE INVENTION

An object of the invention is particularly to provide child safety and to prevent material and non-material damages, by locking all kinds of articles in the form of a cabinet and drawer such away not to be unlocked by children.

Another object of the invention is to provide an application which is easy and practical.

Another object of the invention is not to cause waste of time during use.

A further object of the invention is to provide a mechanism, the operating logic of which is hard to be understood by children.

Another object of the invention is not to cause an aesthetic deformation on the articles as it is integrated into the inner surface of the articles, not to the outer surfaces thereof.

A further object of the invention is to have, but not limited to, an appropriate structure so as to provide an easy production, logistic advantages, aesthetical gains, advantages of long-term use, low production costs, and direct and indirect advantages.

Another object of the invention is to be able to have variations suitable for a single drawer and a single cabinet door.

A further object of the invention is that the drawers and cabinets may be included in the production during manufacturing process.

### DESCRIPTION OF FIGURES

FIG. 1 is a perspective view of a right wall.

FIG. 2 is a perspective view of a left wall.

FIG. 3 is a perspective view of an upper tab lever.

FIG. 4 is a perspective view of a lower tab lever.

FIG. 5 is a view of an upper button spring.

FIG. 6 is a view of a lower button spring.

FIG. 7 is a perspective view of an upper button spring cover.

FIG. 8 is a perspective view of a lower button spring cover.

FIG. 9 is a perspective view of an upper leg.

FIG. 10 is a perspective view of a lower leg.

FIG. 11 is a perspective view of a double-sided tape of the right wall.

FIG. 12 is a perspective view of a double-sided of the upper leg.

FIG. 13 is a perspective view of a double-sided of the lower leg.

FIG. 14 is an exploded view of a Child Safety Lock for Cabinets and Drawers

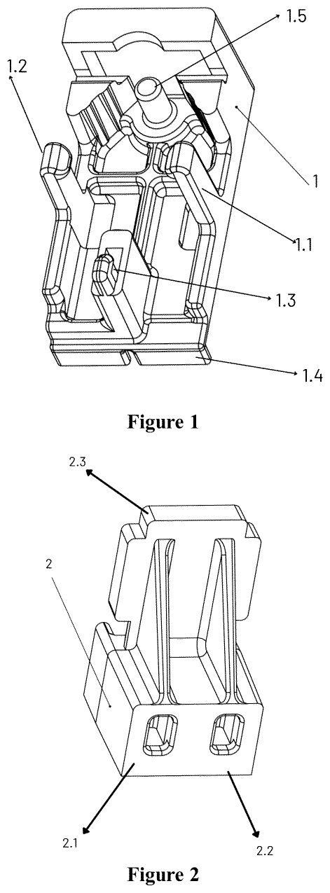

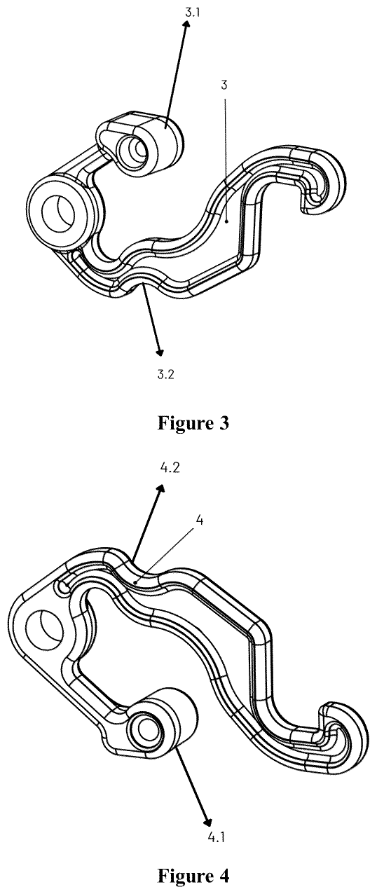

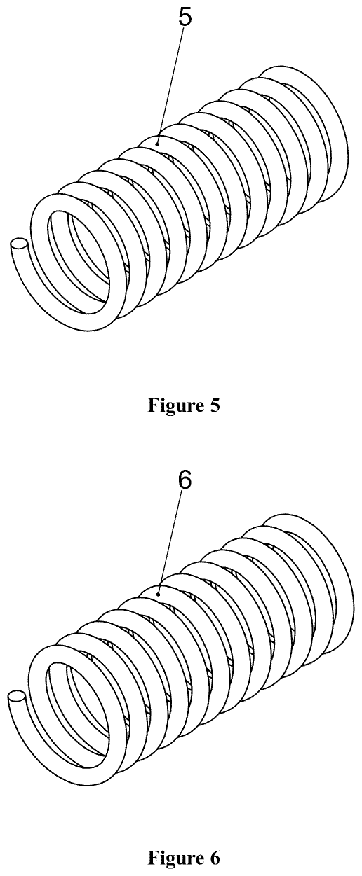

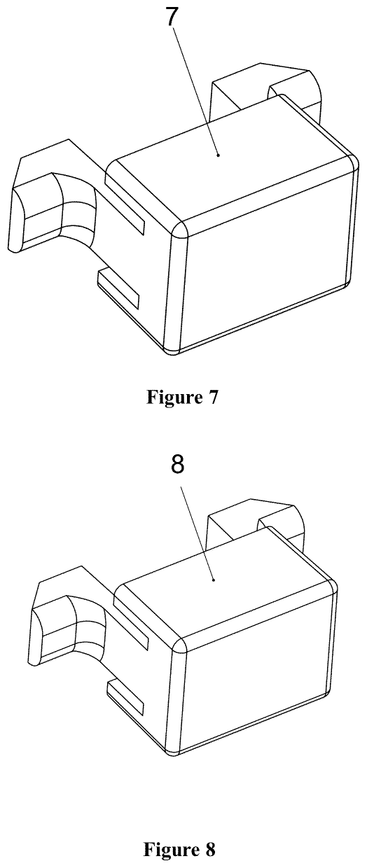

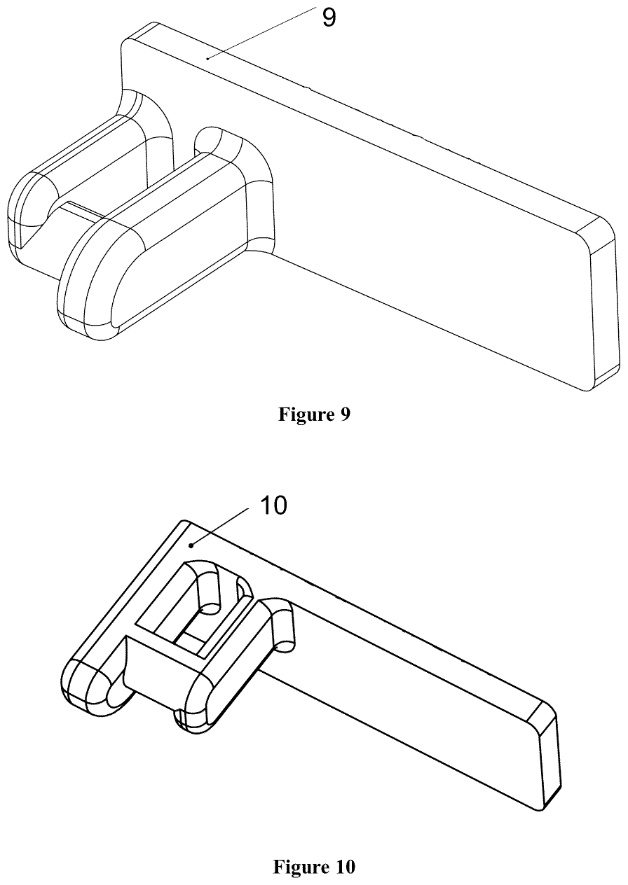

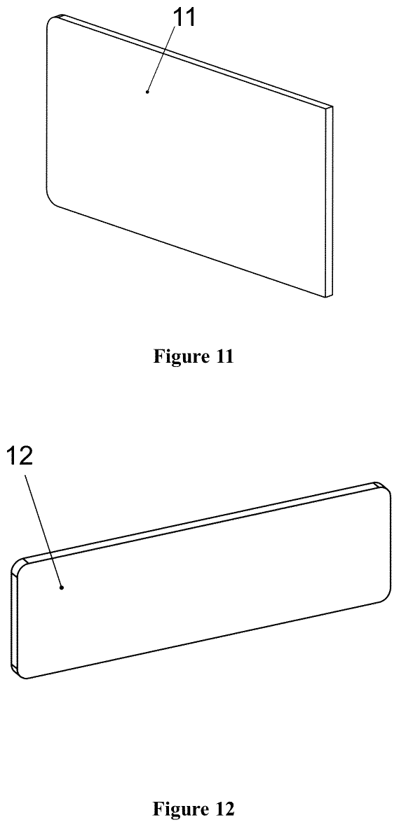

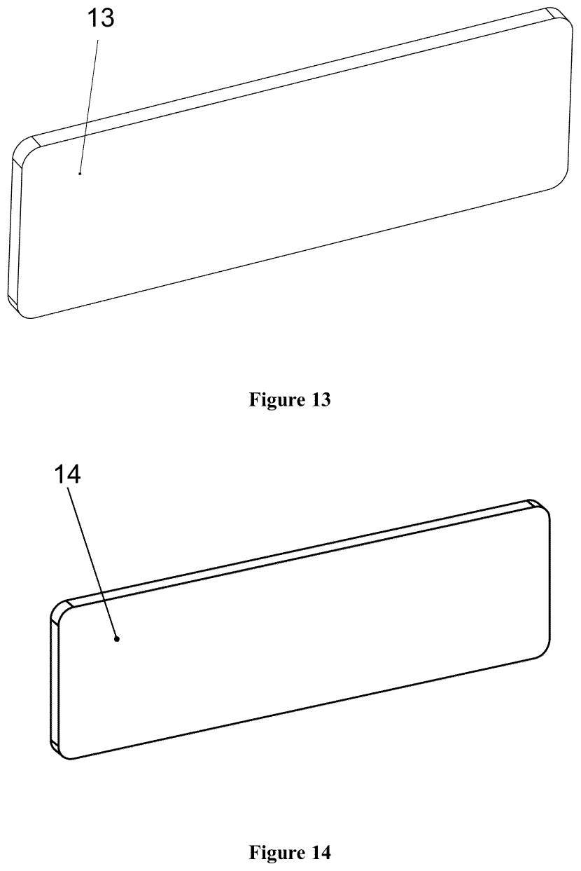

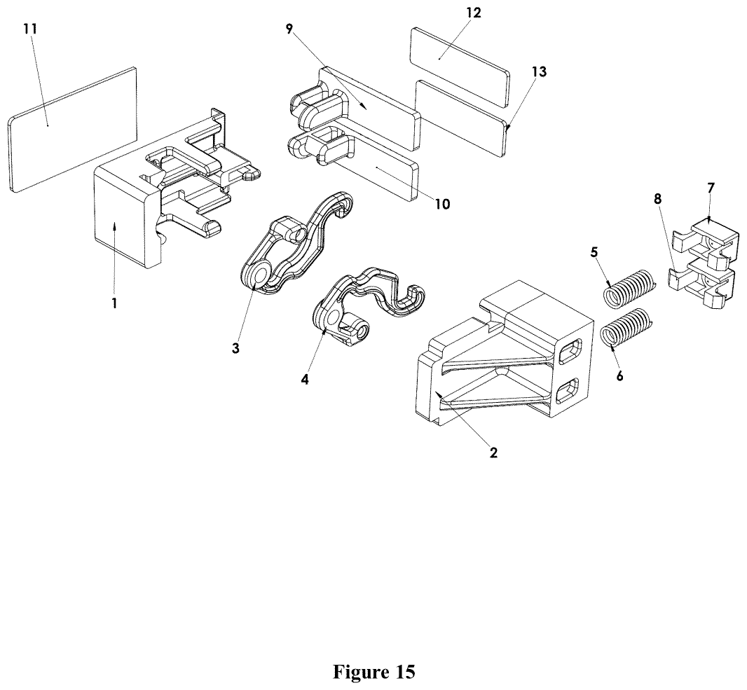

### REFERENCE LIST

1—Right Wall
1.1—Upper Locking Tab
1.2—Lower Locking Tab
1.3—Front Locking Tab
1.4—Mounting Guide Abutment
1.5—Mounting Pin Bearing for Upper and Lower Tab Lever
2—Left Wall
2.1—Lower Button Spring Seat
2.2—Upper Button Spring Seat
2.3—Left Wall Locking Flank
3—Upper Tab Lever
3.1—Upper Tab Lever Unlocking Button
3.2—Upper Tab Lever Unlocking Bearing
4—Lower Tab Lever
4.1—Lower Tab Lever Unlocking Button
4.2—Lower Tab Lever Unlocking Bearing
5—Upper Button Spring
6—Lower Button Spring
7—Upper Button Spring Cover
8—Lower Button Spring Cover
9—Upper Leg
10—Lower Leg
11—Double-Sided Tape for Right Wall
12—Double-Sided Tape for Upper Leg
13—Double-Sided Tape of Lower Leg

### DETAILED DESCRIPTION OF THE INVENTION

The invention has been designed for engaging with a main body of the mechanism comprising a Left Wall (2), an Upper Tab Lever (3), a Lower Tab Lever (4), an Upper Button Spring (5), a Lower Button Spring (6), an Upper Button Spring Cover (7) and a Lower Button Spring Cover (8) contained in the mechanism, and has also been designed as a right Wall (1) on which there are an Upper Locking Tab (1.1) for being locked to the Left Wall (2), a Lower Locking Tab (1.2), a Front Locking Tab (1.3), a Mounting Guide Abutment (1.4), and a Mounting Pin bearing (1.5) for the Upper and Lower Tab Lever.

The invention has been designed for engaging with a main body of the mechanism comprising a Right Wall (1), an Upper Tab Lever (3), a Lower Tab Lever (4), an Upper Button Spring (5), a Lower Button Spring (6), an Upper Button Spring Cover (7) and a Lower Button Spring Cover (8) contained in the mechanism, and has also been designed as a Left Wall (2), on which there are a Lower Button Spring Seat (2.1), an Upper Button Spring Seat (2.2) and a Left Wall Locking Flank (2.3).

The invention has been designed as an Upper Tab Lever (3) contained in the mechanism, which is located between the Right Wall (1) and the Left Wall (2) together with the Lower Tab Lever (4) and performs the locking and unlocking processes with the Upper Leg (9) which is inserted through the upper channel on the main body of the mechanism, wherein it comprises an Upper Tab Lever Unlocking Button (3.1), a Lower Tab Lever Unlocking Button (4.1) and a Bearing (3.2) of the Upper Tab Lever Unlocking Button for a manual unlocking process.

The invention has been designed as a Lower Tab Lever (4) contained in the mechanism, which is located between the Right Wall (1) and the Left Wall (2) together with the Upper Tab Lever (3) and performs the locking and unlocking processes with the Lower Leg (10) which is inserted through the lower channel on the main body of the mechanism, wherein it comprises a Lower Tab Lever Unlocking Button (4.1), a Upper Tab Lever Unlocking Button (3.1) and a Bearing (4.2) of the Upper Tab Lever Unlocking Button for manual unlocking process.

The invention has been designed as an Upper Button Spring (5) contained in the mechanism, which is inserted into an upper button recess on the exterior side of the Left Wall (2) of the main body of the mechanism consisting of a Right Wall (1), a Left Wall (2), an Upper Tab Lever (3), and a Lower Tab Lever (4), and positions the Upper Leg (6) back by pushing it, wherein the Upper Leg is inserted through an upper channel in which the Upper Tab Lever (3) of the main body of the mechanism is located, thereby allowing the mechanism to remain locked.

The invention has been designed as a Lower Button Spring (6) contained in the mechanism, which is inserted into a lower button recess on the exterior side of the Left Wall (2) of the main body of the mechanism consisting of a Right Wall (1), a Left Wall (2), an Upper Tab Lever (3), and a Lower Tab Lever (4), and positions the Lower Leg (7) back by pushing it, wherein the Lower Leg is inserted through a lower channel in which the Lower Tab Lever (4) of the main body of the mechanism is located, thereby allowing the mechanism to remain locked.

The invention has been designed as an Upper Button Spring Cover (7) of the Upper Button Spring (5) contained in the mechanism, which is located in the upper recess on the outer surface of the Left Wall (2) and allows the Upper Tab Lever (3) to be locked by positioning the Upper Leg (9) on the drawer side back.

The invention has been designed as a Lower Button Spring Cover (8) of the Lower Button Spring (6), contained in the mechanism, which is located in the lower recess on the exterior surface of the Left Wall (2) and allows the Lower Tab Lever (4) to be locked by positioning the Lower Leg (10) on the drawer side back.

The invention has been designed as an Upper Leg (9) contained in the mechanism, which is inserted into the upper channel of the mechanism comprising the Upper Tab Lever (3) of the main body of the mechanism consisting of a Right Wall (1), a Left Wall (2), an Upper Tab Lever (3), a Lower Tab Lever (4), an Upper Button Spring (5), a Lower Button Spring (6), an Upper Button Spring Cover (7) and a Lower Button Spring Cover (8), provides a locking function by being pushed and positioned back by the Upper Button Spring (5) and the Upper Button Spring Cover (7) and enables the lower drawer or a door of the cabinet to be opened by triggering the Lower Tab Lever (4) to unlock when the drawer front or the door of the cabinet is pushed forward.

The invention has been designed as a Lower Leg (10) contained in the mechanism, which is inserted into the lower channel of mechanism comprising the Lower Tab Lever (4) of the main body of the mechanism consisting of a Right Wall (1), a Left Wall (2), an Upper Tab Lever (3), a Lower Tab Lever (4), an Upper Button Spring (5), a Lower Button Spring (6), an Upper Button Spring Cover (7) and a Lower Button Spring Cover (8), provides a locking function by being pushed and positioned back by the Lower Button Spring (6) and the Lower Button Spring Cover (8) and enables the lower drawer or the door of the cabinet to be opened by triggering the Upper Tab Lever (3) to unlock when the drawer front or the door of the cabinet is pushed forward.

The invention has been designed as a Double-Sided (11) Tape for the Right Wall, which is applied to the outer surface of the Right Wall (1) and allows the Child Safety Lock Mechanism for Cabinets and Drawers to be mounted to the corresponding position.

The invention has been designed as a Double-Sided Tape (12) for the Upper Leg, which allows the Upper Leg (9) to be mounted on the drawer and cabinet door.

The invention has been designed as a Double-Sided Tape (13) for the Lower Leg, which allows the Lower Leg (10) to be mounted on the drawer and cabinet door.

The Upper Tab Lever (3) is inserted into the Mounting Pin Bearing (1.5) for the Upper and Lower Tab Lever on the Right Wall (1). Thereafter, the Lower Tab Lever (4) is disposed on the Upper Tab Lever (3) inserted into the Mounting Pin Bearing (1.5) for the Lower Tab Lever. Then, the Upper Button Spring (5) and the Lower Button Spring (6) are disposed in the Upper and Lower Button Spring Seat (2.1 and 2.2) on the outer side of the Left Wall (2), and the Upper Button Spring Cover (7) and the Lower Button Spring Cover (8) are placed in the Upper and Lower Button Spring Seat (2.1 and 2.2) and locked. Then, the Left Wall (2) is engaged with the Right Wall (1) in such a way to be locked to the Upper Locking Tab (1.1), the Lower Locking Tab (1.2) and the Front Locking Tab (1.3). Subsequently, the Upper Leg (9) is inserted into the upper channel and the Lower Leg (10) is inserted into the lower channel, which are located on the main body of the mechanism, the mounting process of which is completed. Thereafter, the Double-Sided Tape (11) for the Right Wall is applied to the outer surface of the Right Wall (1). Then, the Double-sided Tape (12) for the Upper Leg and the Double-Sided Tape (13) for the Lower Leg are applied to the corresponding sites of the Upper Leg (9) and the Lower Leg (10). Now, the Child Safety Lock for Cabinets and Drawers is ready to use.

In case of a mounting process for a drawer in the Child Safety Lock for Cabinets and Drawers, the backing of the Double-Sided Tape (11) for the right Wall on the outer surface of the Right Wall (1) is peeled off, and 1 each tape is mounted on the right wall and left wall of the drawer box for positioning the Child Safety Lock for Cabinets and Drawers, such that the junction point of the upper and lower drawer fronts is centered. The backings of the Double-Sided Tapes (12, 13) for the Upper and Lower Legs on the corresponding locations of the Upper Legs (9) and Lower Legs (10) located on the Child Safety Lock for Cabinets and Drawers mounted on the right and left walls of the drawer are peeled off, the drawers are closed, and the tapes are adhesively mounted on the corresponding parts of the drawer fronts of the Upper Leg (9) and Lower Leg (10). So, the mounting process of the Child Safety Lock for Cabinets and Drawers for the drawers is completed. When the locked drawers are desired to be opened, the lower drawer is pushed forward in the closing direction in order to open the upper drawer, the lower drawer is replaced slightly in the closing direction when it is pushed forward, the Upper Tab Lever (3) is moved upwardly by the Lower Leg (10) on the drawer front, which is traveled through the lower channel on the child safety lock mechanism for cabinets and drawers, so that the Upper Leg (9) is unlocked. The upper drawer in a free state is pulled and opened. When the upper drawer is closed, the Upper Leg (9) unlocks the drawer by entering the upper channel on the Child Safety Lock for Cabinets and Drawers and locking the Upper Tab Lever (3). Similarly, the upper drawer is pushed forward in the closing direction in order to open the lower drawer, the upper drawer is replaced slightly in the closing direction when it is pushed forward, the Lower Tab Lever (4) is moved downwardly by the Upper Leg (9) on the drawer front, which is traveled through the upper channel on the child safety lock mechanism for cabinets and drawers, so that the Upper Leg (9) is unlocked. The lower drawer in a free state is pulled and opened. When the lower drawer is closed, the Lower Leg (10) locks the Lower Tab Lever (4) by entering the lower channel on the Child Safety Lock for Cabinets and Drawers, thereby locking the drawer. The upper and lower button springs (5, 6) which are located on the Left Wall (2) and consist of the Upper Button Spring (5), Lower Button Spring (6), Upper Button Spring Cover (7) and Lower Button Spring Cover (8) positions the drawer in the locked state if the drawers are moved back and forth arbitrarily, or a braked rail system is used in the drawers, thereby remaining the mechanism in the locked state.

In case of a mounting process for a cabinet in the Child Safety Lock for Cabinets and Drawers, the backing of the Double-Sided Tape (11) for the right Wall on the outer surface of the Right Wall (1) is peeled off, and one tape is mounted on the upper or lower wall of the cabinet frame for positioning the Child Safety Lock for Cabinets and Drawers, such that the junction point of the right cabinet door and left cabinet door is centered. The backings of the Double-Sided Tapes (12, 13) for the Upper and Lower Legs on the corresponding locations of the Upper Legs (9) and Lower Legs (10) located on the Child Safety Lock for Cabinets and Drawers mounted on the right and left walls of the cabinet frame are peeled off, the cabinet doors are closed, and the tapes are adhesively mounted on the corresponding parts of the cabinet doors of the Upper Leg (9) and the Lower Leg (10). So, the mounting process of the Child Safety Lock for Cabinets and Drawers for the cabinets is completed. When the locked cabinet doors are desired to be opened, the right cabinet door is pushed forward in the closing direction in order to open the left cabinet door, the right cabinet door is replaced slightly in the closing direction when it is pushed forward, the Upper Tab Lever (3) is moved upwardly by the Lower Leg (10) on the cabinet door, which is traveled through the lower channel on the child safety lock mechanism for cabinets and drawers, so that the Upper Leg (9) is unlocked. The left cabinet door in a free state is pulled and opened. When the left cabinet door is closed, the Upper Leg (9) locks the cabinet door by entering the upper channel on the Child Safety Lock for Cabinets and Drawers and locking the Upper Tab Lever (3). Similarly, the left cabinet door is pushed forward in the closing direction in order to open the right cabinet door, the left cabinet door is replaced slightly in the closing direction when it is pushed forward, the Lower Tab Lever (4) is moved downwardly by the Upper Leg (9) on the right cabinet door, which is traveled through the upper channel on the child safety lock mechanism for cabinets and drawers, so that the Lower Leg (10) is unlocked. The right cabinet door in a free state is pulled and opened. When the right cabinet door is closed, the Lower Leg (10) locks the cabinet door by entering the lower channel on the Child Safety Lock for Cabinets and Drawers and locking the Lower Tab Lever (4).

The upper and lower button springs (5, 6) which are located on the Left Wall (2) and consist of the Upper Button Spring (5), Lower Button Spring (6), Upper Button Spring Cover (7) and Lower Button Spring Cover (8) positions the drawers in the locked state if the cabinet doors are moved back and forth arbitrarily, or a braked rail system is used in the cabinet doors, thereby remaining the mechanism in the locked state. When one of the Cabinet Doors are in an open position and the other Cabinet Door is desired to be opened without closing the open Cabinet Door, if the Right Door is open, the Lower Tab Lever Unlocking Button (4.1) on the Lower Tab Lever (4) is pressed manually in order to unlock the Left Cabinet Door, and the Lower Tab Lever Unlocking Button (4.1) is fitted in the Bearing (3.2) of the Upper Tab Lever Unlocking Button on the Upper Tab Lever (3), unlocks the Upper Leg (9) by pushing the Upper Tab Lever (3), so that the unlocked Left Cabinet Door is pulled and opened. If the Left Door is open, the Upper Tab Lever Unlocking Button (3.1) on the Upper Tab Lever (3) is pressed manually in order to unlock the Right Cabinet Door, and the Upper Tab Lever Unlocking Button (3.1) is fitted in the Bearing (4.2) of the Lower Tab Lever Unlocking Button on the Lower Tab Lever (4), unlocks the Lower Leg (10) by pushing the Lower Tab Lever (4) so that the unlocked Right Cabinet Door is pulled and opened.

1. A child safety lock mechanism for cabinets and drawers, comprising:
at least one right wall comprising:
an upper locking tab;
a lower locking tab;
a front locking tab;
a mounting guide abutment; and
a mounting pin bearing for an upper and lower table lever;
at least one left wall comprising:
a lower button spring seat;
an upper button spring seat; and
a left wall locking flank;
at least one upper tab lever comprising:
an unlocking button for the upper tab lever; and
an unlocking button bearing for the upper tab lever;
at least one lower tab lever comprising:
an unlocking button for the lower tab lever; and
an unblocking button bearing for the lower tab lever;
an upper button spring;
a lower button spring;
an upper button spring cover;
a lower button spring cover;
an upper leg;
a lower leg;
a double-sided tape for a right wall;
a double-sided tape for an upper leg; and
a double-sided tape for a lower leg.

2. The child safety lock mechanism for cabinets and drawers according to claim 1, further comprising a right wall which is engaged with the main body of the mechanism comprising:
a left wall;
an upper tab lever;
a lower tab lever;
an upper button spring;
a lower button spring;
an upper button spring cover; and
a lower button spring cover.

3. The child safety lock mechanism for cabinets and drawers according to claim 1, further comprising a left wall which is engaged with the main body of the mechanism comprising:
a right wall;
an upper tab lever;
a lower tab lever;
an upper button spring;
a lower button spring;
an upper button spring cover; and
a lower button spring cover.

4. The child safety lock mechanism for cabinets and drawers according to claim 1, further comprising an upper tab lever which is located between the right wall and the left wall together with the lower tab lever, and performs the locking and unlocking functions with the upper leg inserted through the upper channel on the main body of the mechanism.

5. The child safety lock mechanism for cabinets and drawers according to claim 1, further comprising a lower tab lever located between the right wall and the left wall together with the upper tab lever, and performs the locking and unlocking functions with the lower leg inserted through the lower channel on the main body of the mechanism.

6. The child safety lock mechanism for cabinets and drawers according to claim 1, further comprising an upper button spring which is inserted into an upper button recess on the exterior side of the left wall of the main body of the mechanism consisting of a right wall, a left wall, an upper tab lever, and a lower tab lever, and positions the upper leg back by pushing it, wherein the upper leg is inserted through an upper channel in which the upper tab lever of the main body of the mechanism is located, thereby allowing the mechanism to remain locked.

7. The child safety lock mechanism for cabinets and drawers according to claim 1, further comprising a lower button spring which is inserted into a lower button recess on the exterior side of the left wall of the main body of the mechanism consisting of a right wall, a left wall, an upper tab lever and a lower tab lever and positions the lower leg back by pushing it, wherein the lower leg is inserted through a lower channel in which the lower tab lever of the main body of the mechanism is located, thereby allowing the mechanism to remain locked.

8. The child safety lock mechanism for cabinets and drawers according to claim 1, further comprising an upper button spring cover of the upper button spring which is located in the upper recess on the outer surface of the left wall and allows the upper tab lever to be locked by positioning the upper leg on the drawer side back.

9. The child safety lock mechanism for cabinets and drawers according to claim 1, further comprising a lower button spring over of the lower button spring which is located in the lower recess on the exterior surface of the left wall and allows the lower tab lever to be locked by positioning the lower leg on the drawer side back.

10. The child safety lock mechanism for cabinets and drawers according to claim 1, wherein the main body of the mechanism comprises:
a right wall;
a left wall;
an upper tab lever;
a lower tab lever;
an upper button spring;
a lower button spring;
an upper button spring cover; and
a lower button spring comprising an upper leg which is inserted into the upper channel of the mechanism comprising the upper tab lever, provides a locking function by being pushed and positioned back by the upper button spring and the upper button spring cover and enables the lower drawer or a door of the cabinet to be opened by triggering the lower tab lever to unlock when the drawer front or the door of the cabinet is pushed forward.

11. The child safety lock mechanism for cabinets and drawers according to claim 1, wherein the main body of the mechanism comprises:
a right wall;
a left wall;
an upper tab lever;
a lower tab lever;
an upper button spring;
a lower button spring;
an upper button spring cover; and
a lower button spring comprising a lower leg which is inserted into the lower channel of the mechanism comprising the lower tab lever, provides a locking function by being pushed and positioned back by the lower button spring and the lower button spring cover and enables the upper drawer or the door of the cabinet to be opened by triggering the upper tab lever to unlock when the drawer front or the door of the cabinet is pushed forward.

12. The child safety lock mechanism for cabinets and drawers according to claim 1, further comprising a double-sided tape for the right wall, which is applied to the outer surface of the right wall and allows the child safety lock mechanism for cabinets and drawers to be mounted to the corresponding position.

13. The child safety lock mechanism for cabinets and drawers according to claim 1, further comprising a double-sided tape for the upper leg, which allows the upper leg to be mounted to a drawer front or a door of the cabinet.

14. The child safety lock mechanism for cabinets and drawers according to claim 1, further comprising a double-sided tape for the lower leg, which allows the lower leg to be mounted to a drawer front or a door of the cabinet.

15. A method for operating a drawer in the child safety lock mechanism for cabinets and drawers according to claim 1, comprising the following steps:
pushing the lower drawer forward in the closing direction in order to open the upper drawer;
replacing the lower drawer slightly in the closing direction when it is pushed forward;
moving the upper tab lever upwardly by the lower leg on the drawer front, which is traveled through the lower channel on the child safety lock mechanism for cabinets and drawers;
unlocking the upper leg;
pulling and opening the upper drawer in a free state;
locking the upper tab lever by the upper leg which is inserted through the upper channel on the child safety lock mechanism for cabinets and drawers when the upper drawer is closed, thereby bringing the drawer to a locked state;
similarly, pushing the upper drawer forward in the closing direction to open the lower drawer, replacing the upper drawer slightly in the closing direction when it is pushed forward;
moving the lower tab lever downwardly by the upper leg on the drawer front, which is traveled through the upper channel on the child safety lock mechanism for cabinets and drawers;
unlocking the lower leg;
pulling and opening the lower drawer in a free state;
locking the lower tab lever by the lower leg which is inserted through the lower channel on the child safety lock mechanism for cabinets and drawers when the lower drawer is closed, thereby bringing the drawer to a locked state; and
remaining the mechanism in a locked state when the upper and lower button springs which is located on the left wall and consists of an upper button spring; a lower button spring; an upper button spring cover; and a lower button spring cover positions the drawer in the locked state if the drawers are moved back and forth arbitrarily, or a braked rail system is used in the drawers.

16. The method according to claim 15, further comprising the following steps:
pushing the right cabinet door forward in the closing direction in order to open the left cabinet door;
replacing the right cabinet door slightly in the closing direction when it is pushed forward;
moving the upper tab lever upwardly by the lower leg on the cabinet door, which is traveled through the lower channel on the child safety lock mechanism for cabinets and drawers, thereby unlocking the upper leg;
pulling and opening the left cabinet door in a free state;
locking the upper tab lever by the upper leg which is inserted through the upper channel on the child safety lock mechanism for cabinets and drawers when the left cabinet door is closed, thereby bringing the cabinet door to a locked state;
similarly, pushing the left cabinet door forward in the closing direction in order to open the right cabinet door;
replacing the left cabinet door slightly in the closing direction when it is pushed forward;
moving the lower tab lever downwardly by the upper leg on the left cabinet door, which is traveled through the upper channel on the child safety lock mechanism for cabinets and drawers, thereby unlocking the lower leg;
pulling and opening the right cabinet door in a free state;
locking the lower tab lever by the lower leg which is inserted through the lower channel on the child safety lock mechanism for cabinets and drawers when the right cabinet door is closed.

17. A locking mechanism which allows the other cabinet door to be opened without closing the open cabinet door when one of the cabinet doors are in an open position according to claim 1, wherein if the right door is open, the upper leg is unlocked by pushing the upper tab lever after manually pressing the lower tab lever unlocking button on the lower tab lever and fitting the lower tab lever unlocking button in the bearing of the upper tab lever unlocking on the upper tab lever, in order to unlock the left cabinet door.

18. A locking mechanism which allows the other cabinet door to be opened without closing the open cabinet door when one of the cabinet doors are in an open position according to claim 1, wherein if the left door is open, the lower leg is unlocked by pushing the lower tab lever after manually pressing the upper tab lever unlocking button on the upper tab lever and fitting the upper tab lever unlocking button in the bearing of the lower tab lever unlocking on the upper tab lever, in order to unlock the left cabinet door.
